(19) United States
(12) Patent Application Publication
(10) Pub. No.: US 2003/0129340 A1
(43) Pub. Date: Jul. 10, 2003

(54) METHOD OF INCREASING THE STRENGTH AND FATIGUE RESISTANCE OF FIBER REINFORCED COMPOSITES

(76) Inventors: MARTIN CHARLES FLAUTT, GRANVILLE, OH (US); DAVID GEORGE MILLER, PICKERINGTON, OH (US); BYRON JEFFREY HULLS, REYNOLDSBURG, OH (US)

Correspondence Address: DOCKET ADMINISTRATOR, OWENS CORNING, 2790 COLUMBUS ROAD BUILDING 54, GRANVILLE, OH, 43023

(21) Appl. No.: 09/364,219

(22) Filed: Jul. 29, 1999

(51) Int. Cl. B65D 1/00; B32B 1/08

(52) U.S. Cl. 428/36.9

(57) ABSTRACT

A resin system for making fiber-reinforced composites, which is obtained by dispersing a particulate resin material into a thermosetting resin matrix. The resin composition is combined with a reinforcing fiber material to form composites of high strength retention and resistance to cyclic fatigue upon curing. The invention also relates to composite materials and articles thereof.

TECHNICAL FIELD AND INDUSTRIAL APPLICABILITY IF THE INVENTION

This application is related to application Ser. No. ______ (Attorney Docket No. OC24405A), which is being concurrently filed herewith, and which is incorporated herein by reference in its entirety.

This application relates to an improved resin composition for use in fiber-reinforced composite materials. More particularly, the invention relates to a composition used to provide the matrix for wound fiber reinforced composites in which the retention of matrix resin between the fibers in the composite matrix is enhanced by adding a particulate resin material to the matrix resin. The resulting composition possesses enhanced physical properties, and demonstrates superior mechanical performance. Also described are composite materials containing such resin compositions, and articles made from the composites.

### BACKGROUND OF THE INVENTION

Fiber reinforced composites have become widely recognized over the last fifty years for their usefulness as load-bearing materials having excellent thermal and impact resistance, high tensile strength, good chemical resistance and insulating properties. The term “composite” broadly applies to any combination of individual materials, usually built up in layers. The materials may include, for example, cementitious compositions, ceramics or synthetic materials such as plastic resins.

Generally, in fiber-reinforced plastic composites, fibers, typically of glass or carbon, are impregnated within a resin matrix to create a strengthened material. The resulting material has physical properties that are superior to the individual characteristics of the fibers or the resins. Thus, although the fibers are fragile in nature and susceptible to handling damage, and the resin may be soft and overly pliable, when the fibers are incorporated into the resinous matrix, the material so formed has improved strength and durability. The glass fibers strengthen and stiffen the matrix for load-bearing, while the matrix resin binds the fibers together and spreads the load across them, thereby protecting them from impact and environmental deterioration. By selecting the matrix, fiber and manufacturing process, the composites can be tailored to meet desired performance requirements. For example, filament wound composites are made using continuous fibers that conform to a desired shape. To make these composites, one or more multi-filament glass strands or rovings are passed through a bath of resin, then the resin-coated strand is wound onto a mandrel of the desired shape. The shaped article is then cured to solidify the resin.

It has long been recognized that fiber-reinforced composites are extremely sensitive to the bonding strength between the fiber and the matrix. R. J. Kerans, The Role of the Fiber-Matrix Interface In Ceramic Composites, Ceram. Bull. 68 (2): 429-442 (1989); H. C. Cao et al., Effect Of Interfaces on the Properties of Fiber-Reinforced Ceramics, J. Am. Ceram. Soc. 73:1691 (1990); A. G. Evans et al., The Role Of Interfaces in Fiber-Reinforced Brittle Matrix Composites, Composites Sci. & Tech. 42:3-24 (1991). This recognition has led to significant efforts to modify the interface between the fiber and polymer, and so improve the product strength.

A variety of polymer matrix resins have been used to design and fabricate fiber-reinforced composites. Generally, these resins may be classified into two categories: thermoset and thermoplastic resins. The difference between these resins and their selection for making the composites is based on their chemistry. The choice of either thermoset or thermoplastic resins affects the processing conditions and the final form of the composite material. Both types of resin are comprised of molecular chains, however thermoplastics are processed at high temperatures and maintain their plasticity, enabling them to be reheated and re-shaped more than once. Common thermoplastic resins include polyalphaolefins, nylon, polycarbonate and polyvinyl chloride (PVC). The molecular chains in thermoset resins cross-link during the resin curing process, which is effected using heat and/or a catalyst, and as a result the resin sets into a rigid state. Examples of these resins include polyesters, vinyl esters, phenolics, polybutadienes, polyurethanes, polyimides and epoxies.

While thermosetting resins are preferred in some filament wound composites because of their good mechanical, electrical and chemical-resistance properties, their ease of handling and their relatively low cost, some deficiencies have however been discovered to be associated with their use in this type of composite. For example, researchers have identified certain failure modes that relate to infrastructure uses of the composites. K. Liao et al., Environmental Durability of Fiber-Reinforced Composites for Infrastructural Applications, Proceedings of the Fourth ITI Bridge NDE Users Group Conference (1995). These failure modes include moisture absorption which leads to chemical breakdown of the polymer; creep resulting in rupture; physical aging in which the polymer approaches equilibrium below its glass transition temperature, stress corrosion, weathering and fatigue.

Filament wound composites such as pipes are typically subjected to cyclic periods of intense pressure during their use life. Over time, this repeated exposure to periods of high internal pressure causes fatigue. Fatigue results in fracture, matrix cracking or splitting, or fiber-matrix debonding once the fatigue limit of the composite is exceeded. In manufacturing filament wound composites, then, it is necessary to design a composite that will withstand at least the maximum pressure that the composite will encounter during normal use. Typically in the industry, such composites are designed to withstand at least 5 times the rated maximum use pressure intended for the article being manufactured. Therefore, where the article is, for example, a pipe with a rated use pressure of 3,000 psi (pounds per square inch), the pipe is manufactured and tested to ensure that it can initially withstand exposure to pressures of at least 15,000 psi. To test the product, a length of the pipe may be filled with fluid, then repeatedly pressurized at the rated use pressure until signs of fatigue such as cracks, leakage or bursting are observed.

Efforts have been made to improve the strength of the composites and so improve burst strength, retention and resistance to fatigue. For example, the amount and type of the components may be changed. However, while improving the type and amount of the components can be used to affect the final properties of the composites, traditionally there have been limitations to doing so. Increasing the amount of fiber component will provide more rigidity, but if the proportion of fibers to polymer is too high the composite becomes too brittle. Conversely, when the amount of polymer in relation to the fiber component is high, the polymer may be more easily molded, but the strength properties are decreased.

Moreover, dispersion of the fibers and coating of their surfaces by the matrix resin has a significant impact on the properties of the composites. Consequently, many efforts have been made to improve the compatibility of the fibers and matrix resins and thereby to improve the dispersion and coating of the fibers. For example, enhancing the ability of the resin to impregnate the strand and surround the fiber has been thought to impart improved physical properties to the resulting composites. Steps taken to enhance impregnation have included improving the sizing compositions applied to the fibers, or mechanically assisting impregnation by spreading the fibers in the strand as they pass through the resin bath. However, despite these measures, a need exists for further improvements that will enhance resistance to fatigue. Such a need is met by the products and processes of the invention described herein.

### SUMMARY OF THE INVENTION

It has now been discovered that introducing a finely dispersed particulate resin material into the resin composition used to make a fiber-reinforced composite provides a product of high fatigue resistance and excellent strength retention. The present invention thus relates, in one aspect, to a matrix resin composition for making fiber-reinforced composites, comprising a fluid resin, and a particulate resin material dispersed within the fluid resin. The particulate resin enhances the ability of the matrix resin composition to be retained between the fibers during formation of the composites. Such resin compositions have utility in the manufacture of composite materials by numerous processes, and in particular, in filament-winding operations.

The particulate resin material is added to the composition in an amount sufficient for the purpose of improving the desired properties of burst strength retention and fatigue resistance. Although the mechanism by which the particulate resin improves these properties is not completely understood and several theories of operation may be possible, it is believed that the particulate resin provides a shock-absorbing, cushioning effect within the composites, making them more resistant to impact and high loads. Further, it is believed that the resin particles prevent the fibers from collapsing together during filament winding operations.

Optionally, the invention may further include a foaming or blowing agent, which enhances the composition by reducing the specific density upon activation and increasing the durability of the composites that are formed. It is theorized that the foaming agent generates a number of vapor-filled voids in the resin around the fibers as it decomposes. The presence of these vapor-filled voids is believed to contribute to increasing the durability of the composites.

In another embodiment, the present invention relates to a process of making a fiber-reinforced composite of increased strength and fatigue resistance, comprising the steps of:

a) dispersing an effective amount of a particulate resin material into the matrix resin composition used to form a fiber-reinforced resin composite;

b) contacting the matrix resin composition with a multi-filament, fibrous reinforcing material under conditions that separate the fibers to increase the amount of contact between the matrix resin and the fibers;

c) shaping the resin coated fibers; and

d) curing the matrix resin to form a composite.

In another aspect, the present invention includes a fiber-reinforced composite material comprising the aforementioned resin composition, and further including one or more fiber reinforcing materials known in the art of making reinforcing composites. Lastly, the inventive concept extends to articles manufactured with the composite materials and, which as a consequence possess desirable properties.

In a particularly preferred aspect, the invention relates to a filament wound composite, and a process of filament winding that employs the composite formulation herein described. The filament winding process may be used to make articles such as pipes that exhibit the physical properties associated with this invention.

### DETAILED DESCRIPTION OF THE PREFERRED EMBODIMENTS OF THE INVENTION

The invention provides an improvement in the quality and performance of fiber-reinforced composite materials, which is achieved by adding a particulate resin material to the resin matrix material during the composite formation. Typically, the particulate resin material is introduced to the resin-mixing vessel, along with other composite-making ingredients, after which the fiber material that provides the reinforcing properties in the composite product is added. In an alternate preferred embodiment, a foaming agent may be added. This additive decomposes to form a vapor as the composite sets, and thereby expands the volume of the resin matrix composition sufficiently to increase the strength of the composites, making them especially useful in reinforcing applications. Other additives such as a curing agent or catalyst may be included to facilitate cross-linking of the polymeric molecules.

The resin used to form the matrix for the composite is preferably selected from the group consisting of polyesters, vinyl esters and epoxy resins. Epoxy resins are generally favored because they are highly versatile and can be used in a variety of applications. As an added advantage, they exhibit less shrinkage and higher strength and stiffness properties at moderate curing temperatures. They also produce no by-products during the curing process, and therefore provide a further advantage by being environmentally efficient. Epoxies are also highly resistant to corrosion by solvents, alkalis and some acids. Preferred epoxy resins include low viscosity undiluted bisphenol-A resins. Examples of such resins include DER 330, 331 and 332, which are epoxies manufactured commercially by the Dow Chemical Co. The resins are used in fluid form as a liquid, dispersion or melt, any of these variations being hereinafter collectively referred to as a “liquid”.

In one aspect, the invention comprises adding a second resin in particulate form to the fluid matrix resin. The particle size and the specific gravity of the particulate resin are believed to be important. A particle size that is too small would not be effective because it would not increase the overall resin content. Particles that are too large would be detrimental to the processing operations. Where the specific gravity is too low, the particles will float in the resin. Conversely, if the specific gravity is high, the particles will sink. The specific gravity and the particle size of the resin should therefore be sufficient to permit an even dispersion of the particles in the matrix resin, and the particles should neither sink nor float in the mixture. Preferably therefore, the specific gravity of the particulate resin used in this invention should be approximately the same as the specific gravity of the matrix resin. The particle size preferably ranges from about 1 to about 5 microns in diameter.

The particulate resin is preferably selected from thermoplastic polymers. Preferred thermoplastic polymers that can be used as the particulate resin of the invention include nylons. Most preferably, the particulate resin material is nylon-6, which has a particle diameter size of from about 1 to about 5 microns. An example of this type of resin is Orgasol 1002, which is a brand of particulate nylon-6 available from ELF Atochem Inc.

The proportions of the fluid resin and the particulate resin components should be selected to form a composite in which the particulate resin is effectively dispersed throughout the matrix resin and in the interstitial spaces between the glass fibers. Preferably, the particulate resin material constitutes about 2% to about 10% weight of the total resin material, and, most preferably, is present in an amount of from about 3.5 to about 4.0% by weight. Further, the total amount of the resinous components, including the matrix resin material and the particulate resin material, may generally be from about 30% to about 50% by weight, based on the total weight of the composite. Preferably, the weight of the resin materials is from about 42% to about 46% by weight.

The fiber reinforcing materials that are employed in the composites of this invention are preferably in the form of continuous fibers, strands or rovings. The term “fiber reinforcing material”, as it is used here, includes continuous, unbroken lengths of single filaments, combinations of filaments in the form of fibers, strands made of untwisted fibers, or rovings of bound fibers.

The fiber reinforcing material used in the practice of this invention can be selected from materials that are well known in the art for manufacturing composite structures. Some examples of these include polyaramid, graphite, boron, ceramic or glass fibers, and combinations thereof. Glass fibers are preferred. Glass fibers are conventionally manufactured by eluting molten glass through a heating bushing having precisely drilled apertures which allow formation of streams of glass that are then attenuated and wound onto a collet. Optionally, the glass fibers may be sized by applying a sizing composition that has the effect of smoothing the fiber surface and facilitating surface bonding of subsequent additives to the fiber.

The glass fiber may be selected from several types, including S-glass, E-glass, or a carbon-fiber/glass-fiber hybrid. While a carbon/glass hybrid is highly effective for making the composites of this invention, its high cost is often prohibitive. Accordingly, S- or E-glass is generally preferred. For example, S-glass fiber may be used with excellent results. Usually, such fibers will have a tensile strength of about 3970 Mpa, and a Young's modulus of about 94 Gpa. The glass fiber material component is used in an amount of from about 50% by weight to about 70% by weight, based on the total weight of the composite. Preferably, the amount of the glass fiber material is from about 54% to about 58% by weight.

The resin composition may also include other ingredients. For example, a foaming or blowing agent (hereinafter collectively referred to as a foaming agent) may be added. The foaming agent may be selected from gases such as air, carbon dioxide, helium, argon, nitrogen, volatile hydrocarbons such as propane or butane, and halogenated hydrocarbons, which may be incorporated into the polymer resin matrix by conventional means to provide expansion. Alternatively, a chemical foaming agent that reacts to produce a gas or vapor may preferably be used.

The chemical foaming agent decomposes as a result of a chemical reaction when it is activated, usually by heating. When heated beyond its activation temperature, the foaming agent breaks down and produces a vapor or gaseous decomposition product, which forms pore-like spaces in the resinous matrix. The amount of foaming is not sufficient to affect filament winding ability, but is however sufficient to cause a measurable expansion of the matrix resin. Preferred chemical foaming agents include hydrazine-based agents or carbonamide compounds. The foaming agent most preferred for the practice of this invention is selected from the class of modified azodicarbonamides. An exemplary group of these compounds is the Celogen family of foaming agents, which are commercially available from Uniroyal Chemical Co. An example of these compounds is Celogen 754A, which is an activated azodicarbonamide having a decomposition temperature range of from about 329° F. to about 356° F. Up to the time of the present invention, this azodicarbonamide has been recommended primarily for use as a chemical foaming agent in polyvinyl chloride (PVC) polymers, and to a lesser extent for low-density polyethylenes (LDPE). Another compound belonging to the same family of foaming agents is Celogen OT, having the chemical designation p,p′-oxybis(benzenesulfonyl hydrazide), and a decomposition temperature range of from about 316° F. to about 320° F. These foaming agents are preferred in the compositions of this invention because of their high activation temperatures. At the higher activation temperatures, the foaming agent will begin to produce vapor later in the composite-making process, as the temperature increases. As a result, most of the decomposition occurs after the resin matrix begins to gel, such that the vapor produced on decomposition of the foaming agent is trapped in the resin and not released.

In the compositions of the present invention, the foaming agent is preferably used in an amount ranging from about 0.05% to about 1.0% by weight of the total resin composition. A preferred amount of this ingredient is from about 0.05% to about 0.30% by weight.

A curing or hardening agent may also be included in the resin composition. The curing agent promotes hardening of the resin during the curing phase. Epoxy resins require the addition of a hardener to effect cure. Typical curing agents include aromatic or aliphatic amines or acid anhydrides. The preferred hardening agent in this invention is an acid anhydride, an example of which is sold under the brand name Lindride 66K by Lindau Chemical Co. The curing agent is used in amounts ranging from about 13.5% by weight to about 22.5% by weight, based on the total weight of the composite. The respective proportions of the matrix resin, the curing agent and the blowing agent should be such that the combination will optimize the physical properties of the composite.

Other additives that may optionally be included in the resin matrix composition include impact modifiers, lubricants, mold release agents, pigments and other processing aids.

The resin compositions of the invention are combined with the fibers to form the composites. The compositions of the invention may be used in the manufacture of filament wound composite articles which comprise at least one layer of a resinous matrix material, these layers being embedded with the reinforcing fiber material.

In making filament wound composite pipes, which are a particularly preferred aspect of the invention, fiber materials are coated or impregnated with the resin composition and then cured. The fiber materials, in particular glass fibers, are pulled through a bath containing the resin by a winder apparatus, after which the wet fibers are wound onto rotating mandrels or sleeves to form a pipe. The fibers may optionally be wound over a material designed to form an integral part of the composite structure, such as a heat-shrinkable polyethylene material, which is in direct contact with the sleeve. This material then forms the lower layer of the composite. Alternatively, the fibers may be wound directly onto the mandrel, which functions as a mold or form that is subsequently removed, leaving a freestanding composite article. The direction of the winding can be modified or the rate of winding can be adjusted to obtain a desired winding pattern in layers over the mandrel. The winding action thus forms the layers of the composite and compacts it before curing. Curing is accomplished by exposing the composite to a temperature sufficient to cure the resin, typically a temperature in the range of from about 340° C. to about 360° C. In the case of epoxy resins, a lower temperature may first be used to gel the resin, then a higher temperature phase is used to finalize the cure.

The following examples are representative of the disclosed invention.

### EXAMPLES

### Examples 1-3

As example 1, a resin composition according to this invention was prepared by first mixing a resin matrix polymer with a particulate resin material. The resin selected as the matrix polymer was a fluid epoxy resin, DER 331, which is available from Dow Chemical Co.; and the particulate resin material was a nylon-6 particulate resin, Orgasol 1002, which is commercially available from ELF Atochem Inc. The composition was prepared by first combining about 1777 grams of DER 331 (52.97% weight) with about 67.1 grams (2.00% weight) of the nylon-6 particulate resin while using good agitation to achieve a uniform dispersion. The mixture was heated to about 80° C. to reduce the viscosity of the resin and promote dispersion. High-speed agitation was then applied to de-agglomerate any clumped particles of nylon. In this manner, most of the agglomerated particles were separated into discrete particles and dispersed throughout the matrix. To ascertain the degree of dispersion, a sample of the mixture was examined under a microscope. Discrete particles having a diameter of about 1 micron were observed, as well as small agglomerates having a maximum particle size of about 10 microns. The resin mixture was then cooled to room temperature, after which about 1511 grams (45.03% weight) of Lindride 66K was added as the curing agent.

For example 2, the resin composition having the same epoxy resin and hardener was prepared without the particulate nylon component. About 1796 grams (52.97% wt.) of DER-331 was mixed with about 1.7 grams (0.05% wt.) of Celogen 754A foaming agent, and the mixture was heated until it dissolved. In order to achieve complete dispersion, it was necessary to heat the material to up to 130° C., while using high agitation. After cooling to room temperature, about 1526 grams (45.92% wt.) of Lindride 66K curing agent was added, and the composite was cured as described below.

Each resin system was evaluated by coating a sample onto 5 ends of sized glass that had been dried in a P871 in-line drying unit without post-drying. The in-line drying unit is of the type characterized in U.S. Pat. No. 5,055,119, which is herein incorporated by reference. The coated fiber lengths were then wound via a threader mechanism onto a mandrel to form a length of pipe. Each of the composited pipes so formed consisted of two layers of the resin-fiber combination, built up using twenty passes from the threader. The pipes were then cured in a steam system at a temperature of about 350° F.

As a comparison, in example 3, the physical characteristics of a previously formed filament wound composite made of a resin composition comprising 54% wt. DER 331 and 46% Lindride 66K were also evaluated against the composites of this invention. This composition differed from the present invention in that it did not contain either a particulate resin or a chemical foaming agent.

As a further comparison, example 4 was prepared using a carbon/E-glass hybrid as the fiber-reinforcing material. The fiber was impregnated with a resin matrix composition including particulate nylon-6 in a proportion similar to that used in Example 1, and wound into a composite in the manner previously described.

The products were evaluated for several physical parameters including wall thickness, glass content, and resin content. The volume of vapor entrained in the composite was also calculated for each sample. The volume calculation was performed using a Quantimet SEM™ photomicrograph analysis to measure the volume of the voids in the hardened composite; or, alternatively, the volume of the voids was determined based on volume fractions.

The results are set out in Table 1 below:

TABLE 1

| Example No: | 1 | 2 | 3 | 4 |
|---|---|---|---|---|
| (Fiber/Sizing) | (a) | (a) | (b) | (c) |
| Avg. wall thickness (mils) | 56 | 47 | 37 | 58.6 |
| Glass content (% wt.) | 55.44 | 62.97 | 72.37 | |
| Resin content (% wt.) | 44.56 | 37.03 | 27.63 | 43.63 |
| Vapor Volume (calc. %) | 5.35 | 7.60 | 2.53 | 5.00 |

2
(a) - Zentron 721B AA 750 S-glass strands prepared with a sizing formulation containing A-187, an epoxy silane coupling agent available from OSi, a division of Witco Chemical Co., and 0.1% by weight mono-pentaerythritol (mono-PE). This formulation is disclosed in U.S. Pat. No. 5,262,236 which is hereby incorporated by reference.
(b) - same type of strands as used for (a), wherein the sizing includes A-1120 a diaminosilane as the coupling agent and excludes mono-PE.
(c) - HERCULES AS4^{TM} carbon/E-glass hybrid strands sized with a formulation similar to that used for (a).

As shown by the data, when the Orgasol 1002 particulate nylon component was used in the absence of the foaming agent, the pipe-wall thickness increased to approximately 56 mils. This degree of reinforcement thickness is similar to that obtained using carbon/E-glass hybrid. The calculated air volume for the sample composite closely approximated composites made using carbon/glass fibers as well. Typically, those composites have an air volume of about 4.75%, which is close to the amount of 5.35% that has been discovered for the composites of this invention. These physical properties, which resemble those of composites made using the more expensive carbon/glass fibers, represent unexpected and superior attributes associated with the resin compositions of this invention. It was also observed that using the particulate resin in the absence of the foaming agent caused a slight increase in the amount of entrained vapor. This was an unexpected result, which presumably may be attributed to the higher proportion of resin used in the formulation. The use of the particulate resin may have caused some entrainment of air associated with the particles, or air that was incorporated during mixing may have been prevented from escaping out of the thickened matrix during the winding and curing steps.

The composite of example 2 that contained the resin composition including DER-331 epoxy, the Celogen 754A foaming agent and the Lindride 66K hardener showed an increase in the wall thickness of the pipe from about 37 to about 47 mils. The volume of entrained vapor was also significantly increased, from about 2.53% to about 7.60% of the volume.

The pipes formed using the resin composition of this invention were opaque in appearance, and apart from a few surface irregularities, had a smooth surface. It is believed that the opaque appearance in those samples made using the chemical foaming agent was due to the presence of entrained vapor.

### Examples 5-9

In addition, the type of glass fiber was varied to determine whether the air volume would be affected by the choice of fiber material.

For Examples 5 and 6, two fiber types were alternatively used to form filament wound composites, using resin compositions containing the foaming agent as previously described in Example 2. One of the fibers, designated as a “K” fiber, was a 2000-filament strand of 994 S-glass sized using a formulation according to fiber/sizing type (b), as described above in Table 1, and run as a single end. The sizing formulation applied to this strand contained an emulsified, low molecular weight epoxy resin, a diaminosilane and various lubricants. The other fiber, designated a “Z” fiber, comprised a strand of the same S-glass sized with a formulation containing an emulsified low molecular weight epoxy, a blend of methyl silane and amino silane, and various lubricants. As Examples 7-8, filament wound composites were also prepared using the nylon-containing resin composition of Example 1, which is a preferred embodiment of this invention, and each of the aforementioned types of fiber. Lastly, as example 9, a blend of the two resins in a 50:50 proportion was used to make a composite pipe using the K fiber. The resin blend for this example contained the epoxy resin, the particulate nylon resin and the foaming agent. The concentrations of the foaming agent and the particulate resin were halved in this blend.

The performance characteristics of composites prepared using the different fibers are compared in Table 2.

TABLE 2

| Example | 5 | 6 | 7 | 8 | 9 |
|---|---|---|---|---|---|
| Resin | With foaming | | with nylon-6 | | foaming agent |
| Comp. | agent | | | | + |
| | | | | | nylon-6 |
| Glass fiber | K | Z | K | Z | K |
| Glass (% wt.) | 61.47 | 65.95 | 56.19 | 58.13 | 58.14 |
| Resin (% wt.) | 38.53 | 34.05 | 43.81 | 41.87 | 41.96 |
| Wall | .0516 | .0449 | .0577 | .0518 | .0552 |
| thickness | | | | | |
| (inches) | | | | | |
| Entrained | 9.43 | 9.00 | 8.77 | 3.03 | 8.75 |
| Vapor (% v.) | | | | | |

From the data, it can be observed that the most dramatic results using the particulate resin-containing composition of this invention were obtained using the K fiber. The composites made using this fiber had higher resin content, thicker walls and more entrained vapor than those made using the Z fiber. The difference in results may have been due to the greater strand integrity of the K fiber.

### Examples 10-13

Properties such as burst strength retention and loss were also evaluated using pipes made with the invention, as compared to pipes made using standard composite formulations. Example 10 was constituted using the same ingredients and proportions as indicated for Example 1, above. The blend included 52.97% wt. DER-331, 45.03% wt. Lindride 66K, and 2.0% wt. Orgasol 1002 polymer. Examples 11-13 were standard resin formulations using different types of fiber material: a K fiber, as described above; a Zentron 721B AA 750 glass fiber strand (hereinafter referred to as a “B” fiber strand); and a carbon/E-glass hybrid. The resin formulation used in Examples 11-13 was similar to that used in Example 3, and contained only DER-331 and Lindride 66K.

To prepare the pipes, 16-inch lengths of 3.0 inch diameter heat shrinkable polyethylene tubing were placed on a mandrel and heat shrunk with hot air to conform to the surface. The tubing has a nominal thickness of about 0.20 inches prior to heat shrinking. Five ends of sized glass fiber were wound onto the pipes and steam cured as described for examples 1-3 above. The pipes were then tested to determine the load at which initial burst occurred, and the percentage retention and loss were calculated.

The following protocol was used to determine burst strength retention. A nominal burst strength was first determined by bursting a set of uncycled pipe lengths. Another set of pipe lengths was subjected to cyclic pressure testing, in which the pressure within each pipe length was varied from 0-750 psi for 6,000 cycles. The pipes exposed to cyclic pressure were then burst tested. The burst strength loss was determined according to the formula:

$$1.0 - \frac{burst strength cycled }{burst strength uncycled} \times 100 = \% burst strength loss$$

The percentage burst strength retention was then calculated as:

% burst strength retention=100−% burst strength loss

The results are stated in Table 3.

TABLE 3

| | 10 | 11 | 12 | 13 |
|---|---|---|---|---|
| Example | +nylon-6 | Standard | Standard | Standard |
| Glass fiber type | K | K | B | Carbon/E- |
| | | | | glass |
| Resin Content | 44.24 | 36.57 | 33.70 | 43.63 |
| (% wt) | | | | |
| Entrained vapor | 3.15 | 7.95 | 1.02 | 5.00 |
| (% v.) | | | | |
| Wall thickness | .0557 | .0482 | .0414 | .0586 |
| (in.) | | | | |
| Burst, BI-Initial | 4900 | 4570 | 4877 | 4410 |
| 6000 cycles | 4640 | 3960 | 2953 | 4240 |
| (0-750) | | | | |
| % Retention | 94.69 | 86.65 | 60.55 | 96.15 |
| % Loss | 5.31 | 13.35 | 39.45 | 3.85 |

This data shows that modifying the resin composition by incorporating a particulate resin material, as is done in this invention, greatly increased the burst strength retention of the pipes to over 94%, and correspondingly decreased the bursting loss. Although the burst strength of the standard resin without nylon was improved by using the K fiber as opposed to the B fiber, this difference was probably due only to the difference in physical properties between the fibers. Because the K fiber is stiffer, an inherent amount of air entrainment may have been possible even without the addition of a foaming agent. The increased air volume was therefore responsible for the improvement in burst strength retention between the standards.

More significantly however, the nylon-containing resin composition of this invention demonstrated a burst strength performance comparable to that of carbon/E-glass hybrids. This unexpected result is a highly desirable feature of the filament wound composites prepared according to this invention.

It is believed that Applicants' invention includes many other embodiments which are not herein described, accordingly this disclosure should not be read as being limited to the foregoing examples or preferred embodiments.

We claim:

1. A resin composition for making fiber reinforced composites, comprising a liquid thermosetting resin and a particulate resin material dispersed therein.

2. The resin composition of claim 1, wherein the liquid thermosetting resin is selected from the group consisting of polyesters, vinyl esters and epoxy resins.

3. The resin composition of claim 2, wherein the liquid thermosetting resin is selected from the group consisting of epoxy resins.

4. The resin composition of claim 1, wherein the particulate resin material is present in an amount of from about 2% to about 10% by weight.

5. The resin composition of claim 1, wherein the particulate resin material is a thermoplastic polymer.

6. The resin composition of claim 5, wherein the particulate resin material is a nylon.

7. The resin composition of claim 6, wherein the nylon has a particle size of from about 1 to about 5 microns.

8. The resin composition of claim 1, further comprising a foaming agent.

9. The resin composition of claim 8, wherein the foaming agent is selected from the group consisting of carbonamide compounds.

10. The resin composition of claim 9, wherein the foaming agent is a modified azodicarbonamide.

11. A composite article comprising a fiber reinforcing material disposed within a cured resin composition according to claim 1.

12. The composite article of claim 11, wherein the fiber reinforcing material comprises continuous fibers selected from glass fibers, polymer fibers, carbon fibers or mixtures thereof.

13. The composite article of claim 12, wherein the fiber reinforcing material is continuous glass fiber, and the glass fiber content is from about 50% to about 70% by weight, based on the weight of the total composite.

14. The composite article of claim 11, having a particulate resin content of from about 2% to about 10% by weight of the total resin concentration.

15. The composite article of claim 11, which is made by a filament winding process.

16. The composite article according to claim 15, which is in the form of a pipe.

17. The pipe of claim 16, having a burst strength retention of greater than 90% after cyclic fatigue testing at interval pressures ranging from 0-750 psi for at least 6,000 cycles.

18. A process for making a fiber-reinforced composite, comprising:
a) dispersing a particulate resin material into a matrix resin composition;
b) contacting the resin matrix composition with a fibrous reinforcing material to facilitate impregnation thereof;
c) shaping the resin-impregnated fibrous reinforcing material; and
d) curing the matrix resin to form a composite.

19. The process of claim 18, wherein the particulate resin material is used in a concentration of from about 2% to about 10% by weight of the total resin concentration.

20. The process of claim 18, further comprising the step of adding a foaming agent to the resin matrix composition.
